(19) United States
(12) Patent Application Publication
(10) Pub. No.: US 2017/0308898 A1
(43) Pub. Date: Oct. 26, 2017

(54) SYSTEM AND METHOD OF RECOGNIZING TRANSACTIONS AS TRUSTED

(71) Applicant: AO Kaspersky Lab, Moscow (RU)

(72) Inventors: Evgeny B. Kolotinsky, Moscow (RU); Alexander A. Ermakovich, Moscow (RU); Olga O. Inozemtseva, Moscow (RU)

(21) Appl. No.: 15/198,078

(22) Filed: Jun. 30, 2016

(30) Foreign Application Priority Data
Apr. 25, 2016 (RU) 2016116001

(51) Int. Cl. G06Q 20/40; G06F 17/30; G06Q 20/32

(52) U.S. Cl. CPC G06Q 20/405; G06Q 20/3224; G06F 17/30312; G06Q 20/3221

(57) ABSTRACT

A system and method is provided for recognizing transactions as trusted. An exemplary method includes receiving parameters for a plurality of transactions executed by a user and obtaining one or more attributes of the user from a bank associated with the user. Furthermore, the method includes, for each of the plurality of transactions, determining whether a predetermined number of trust conditions are met by the at least one parameter of the transaction and the at least one attribute of the user; and for each of the plurality of transactions, determining that the transaction is trusted if the predetermined number of trust conditions are met. Moreover, the method includes determining that a verification condition is met if the processor determines that a specified number of the plurality of transactions is deemed trusted; and recognizing a subsequent transaction executed by the user is trusted if the verification condition is met.

### CROSS-REFERENCE TO RELATED APPLICATIONS

This application claims benefit of priority under 35 U.S.C. 119(a)-(d) to a Russian Application No. 2016116001 filed on Apr. 25, 2016, both of which are incorporated by reference herein.

### FIELD OF TECHNOLOGY

The present disclosure generally relates to the field of computer security, and, more specifically, to a system and method for recognizing transactions as trusted.

### BACKGROUND

Due to the widespread use of electronic payment systems, the increasing mobility of the users of payment systems, and the advent of ways of making payments at practically any point on the globe, the number and scale of computer attacks for the purpose of stealing the personal data of users are increasing. By using the stolen user data, hackers can perform fraudulent transactions from the bank accounts of the users. Therefore, the assurance of information security of payment systems and, in particular, the detecting of fraudulent transactions of hackers among the legitimate transactions of users is one of the main priorities of financial institutions such as banks.

At the same time, needlessly complex security systems may cause inconvenience when using the payment systems. In particular, users who often travel among various countries experience difficulties. Banks can block by default the transactions which have been initiated outside the borders of the country in which the bank card was issued. In order to add an exception to the rules for performing operations in certain countries, the user can notify the bank in advance as to an upcoming trip. However, it is extremely inconvenient for users whose work involves constant foreign postings to notify the bank each time not to block the bank card.

Therefore, there is a need for a technology that can identify users who often change their location, and to recognize their transactions as legitimate or trusted.

### SUMMARY

The disclosure herein is related to a system and method for recognizing transactions as trusted.

Specifically, according to one exemplary aspect, a method is provided for verifying electronic transactions as trusted. In this aspect, the method includes receiving, by a processor, at least one parameter for each of a plurality of transactions executed by a user; obtaining, by the processor, at least one attribute of the user from a bank associated with the user; storing, in a database, the parameters of the plurality of transactions and the at least one attribute of the user; for each of the plurality of transactions, determining, by the processor, whether a predetermined number of trust conditions are met by the at least one parameter of the transaction and the at least one attribute of the user; for each of the plurality of transactions, determining, by the processor, that the transaction is trusted if the predetermined number of trust conditions are met; determining that a verification condition is met if the processor determines that a specified number of the plurality of transactions is determined to be trusted; and recognizing a subsequent transaction executed by the user is trusted if the verification condition is met.

According to another aspect, the at least one parameter for each of at least a pair of the plurality of transactions executed by the user comprises a geographical location of a user device that executed each transaction.

According to another aspect, the trust conditions of one of the pair of transactions is that the one transaction was executed at a first geographical location within a predetermined distance of a second geographical location of the user device when the other of the pair of transactions was executed.

According to another aspect, the trust conditions of the pair of transactions is that one of the pair of transactions was executed after a time interval from when the other of the pair of transactions was executed, and the time interval is greater than an expected travel time of the user between two geographical locations.

According to another aspect, the trust conditions include that the geographical location of the user device that executed each transaction coincides within a given accuracy with one of a plurality of a predetermined geographical locations.

According to another aspect, the at least one parameter for each of the plurality of transactions executed by the user comprises at least one of an identifier of the user, an identifier of the transaction, an identifier of a user device that executed the transaction, a time of initiation of the transaction, and a geographical location of the initiation of the transaction.

According to another aspect, the at least one attribute of the user comprises at least one of total funds in a bank account of the user and a type of bank card of the user that corresponds to a bank account of the user.

According to another aspect, the method includes assigning the user to one of a plurality of user classifications based on the at least one parameter for each of the plurality of transactions executed by the user and the at least one attribute of the user; and determining that the verification condition is met based at least partially on the assigned user classification of the user.

According to another aspect, the method includes assigning the user to one of the plurality of user classifications if at least two of the following conditions for the parameters and attributes are satisfied: total funds in a bank account of the user exceed a predetermined threshold; a geographical location for initiation of the transactions coincides with a given accuracy with a geographical location for initiation of transactions of other users of the user classification; a geographical location of the bank of a bank account of the user coincides with a given accuracy with the geographical location of a bank of other users of the user classification class; the total funds in the bank account of the user coincide with totals of the other users of the user classification class within a specified accuracy; and a type of bank card of the user corresponds to a type of bank cards of the other users of the user classification.

According to one aspect, the determining that the predetermined number of trust conditions are met is performed sequentially until the predetermined number is reached.

According to another aspect, a system is provided for verifying electronic transactions as trusted. According to this aspect, the system includes a database; and a processor configured to: obtain at least one parameter for each of a plurality of transactions executed by a user, obtain at least one attribute of the user from a bank associated with the user; store the at least one parameter for each of the plurality of transactions and the at least one attribute of the user in the database, for each of the plurality of transactions, determine whether a predetermined number of trust conditions are met by the at least one parameter of the transaction and the at least one attribute of the user, for each of the plurality of transactions, determine that the transaction is trusted if the predetermined number of trust conditions are met, determine that a verification condition is met if the processor determines that a specified number of the plurality of transactions is determined to be trusted, and recognize a subsequent transaction executed by the user is trusted if the verification condition is met.

According to another aspect, a non-transitory computer readable medium storing computer executable instructions is provided for verifying electronic transactions as trusted. According to this aspect, instructions are provided for: receiving at least one parameter for each of a plurality of transactions executed by a user; obtaining at least one attribute of the user from a bank associated with the user; storing, in a database, the parameters of the plurality of transactions and the at least on attribute of the user; for each of the plurality of transactions, determining whether a predetermined number of trust conditions are met by the at least one parameter of the transaction and the at least one attribute of the user; for each of the plurality of transactions, determining that the transaction is trusted if the predetermined number of trust conditions are met; determining that a verification condition is met if a specified number of the plurality of transactions is determined to be trusted; and recognizing a subsequent transaction executed by the user is trusted if the verification condition is met.

Advantageously, the disclosed system and method reduces the probability of making mistakes of the first kind when checking transactions for being trusted. Moreover, the disclosed system and method simplifies the procedure for verifying the security of transactions.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and particularly pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a block diagram of a system for recognizing transactions as trusted according to an exemplary aspect.

FIG. 2 illustrates a flowchart for a method for recognizing transactions as trusted according to an exemplary aspect.

FIG. 3 illustrates an example of a general-purpose computer system on which the exemplary system and method can be implemented.

### DETAILED DESCRIPTION

Example aspects are described herein in the context of a system, method, and computer program product for recognizing transactions as trusted. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

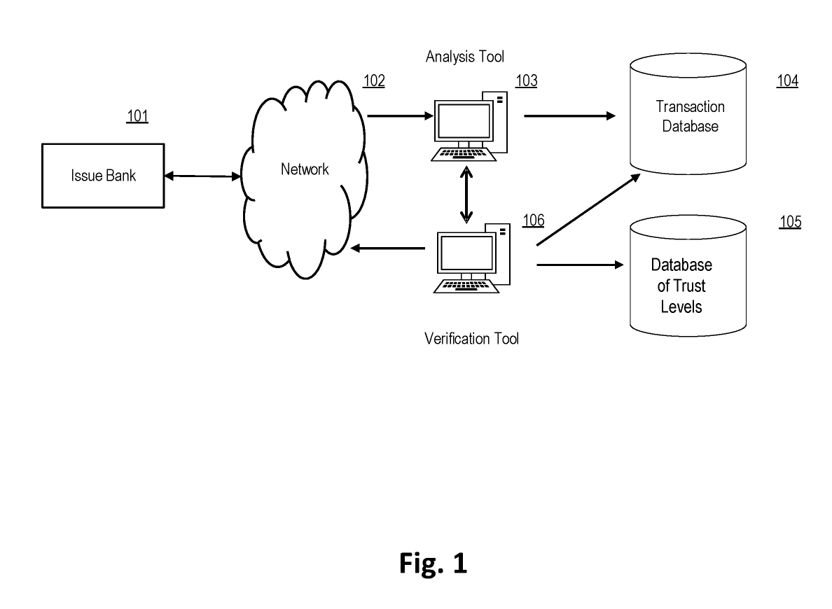

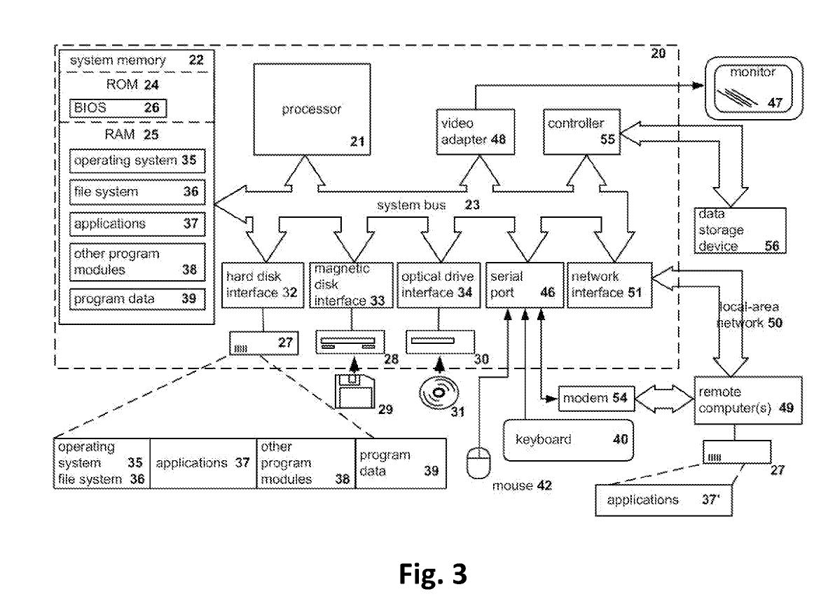

FIG. 1 illustrates a block diagram of a system for recognizing transactions as trusted according to an exemplary aspect. As shown, the system includes an issuer bank 101, linked by a computer network 102 to an analysis tool 103. An exemplary aspect, of the hardware and software configurations for the analysis tool 103 is illustrated below with respect to FIG. 3. The analysis tool 103 in turn is linked to a transactions database 104. According to the exemplary aspect, the analysis tool 103 is configured to obtain from the issuer bank 101 the parameters of the transactions of the users. According to this aspect, a user transaction is any one of the following operations: banking transaction, transaction carried out in an automated teller or a POS terminal, authorization and attempted authorization in the Internet banking system, transactions in Internet banking. The parameters of the transaction can be, for example:
identifier of the user;
identifier of the transaction;
identifier of the user's device from which the transaction was initiated;
date and time of initiation of the transaction; and/or
location of initiation of the transaction.

The analysis tool 103 is also configured to obtain from the issuer bank 101 the user attributes. The user attributes can be, for example:
the total funds in the bank account of the user; and/or
the type of bank card of the user, corresponding to the bank account of the user (for example, Classic type for the Visa® payment system or Maestro type for the MasterCard® payment system).

In an exemplary aspect, the user attributes additionally contain the location of the issuer bank of the user's bank card. In yet another exemplary aspect, additional user attributes can be information on the user having bank cards linked to bonus programs of airline companies.

The analysis tool 103 also serves to store the obtained parameters of the user's transactions and the user attributes in a transactions database 104, which contains the parameters of the transaction and the attributes of the users of the issuer bank. The analysis tool 103 is linked to a verification tool 106 and a database of trust conditions 105, and serves to verify the fulfillment of the trust conditions from the database of trust conditions 105. An exemplary aspect of the hardware and software configurations for the verification tool 106 is illustrated below with respect to FIG. 3. A trust condition determines that the parameters of the user's transactions and the user's attributes are within a range of values assigned by the verification tool 106.

According to an exemplary aspect, one or more trust conditions can be imposed on a certain sequence of transactions of the user. Specific examples of trust conditions will be presented below, when describing aspect exemplary aspects of the disclosure herein. In an exemplary aspect, the trust condition determines limits on the transaction parameters of the user which are assigned for each attribute of the user. Table 1 presents examples of trust conditions. For example, according to the first trust condition, if the user attributes have limits whereby the total funds in the user's bank account are over $10 000, and the bank card has Visa Platinum type, the user's parameters must be within the following limits: any given location for initiation of the transaction.

TABLE 1
Trust conditions

| No | User attributes | Transaction parameters |
|---|---|---|
| 1 | Total funds in the user's bank | Any given location for initiation |
| | account over $10 000 | of the transaction |
| | Bank card has Visa Platinum type | |
| 2 | Total funds in the user's bank | Location for initiation of the |
| | account below $1000 | transaction must coincide with |
| | Bank card has Visa Classic type | location of the card issuer bank |
| 3 | Total funds in the user's bank | Location for initiation of the |
| | account from $1000 to $10 000 | transaction can be anywhere in |
| | | a limited list |

According to an exemplary aspect, the second rule is the most strict and imposes a limitation on the location of the transaction, i.e., it must coincide with the location of the issuer bank.

The third rule is intermediate and imposes less strict limitations on the location for initiation of the transaction—it should be on a limited list. Such a list can be assigned by an administrator and kept in the database of trust conditions 105. For example, if the IP address of the device from which the transaction was initiated belongs to one of the known trusted networks, the trust condition is fulfilled.

If the trust conditions are fulfilled, the verification tool 106 determines the particular transaction as being trusted and accordingly sets a trust flag, which is an indicator determining that the transaction is trusted. The verification tool 106 is also designed to store this trust flag in the transactions database 104 for the user's transaction.

When in the transactions database 104 of the user stored a given number of user transactions in a row and the number of transactions with a trust flag is greater than a specified number of trusted transactions, the verification tool 106 is configured to recognize the subsequent transactions of this user as trusted and to send this information to the issuer bank 101. As a result, the issuer bank 101 allows the execution of the subsequent transactions of the user.

In an exemplary aspect, the issuer bank 101 can use a supplemental analysis to determine whether a transaction is trusted. In one aspect, such a supplemental analysis is provided by the bank's verification of one of the following conditions: (1) are the total funds in the transaction typical of the user or are they substantially higher than the sum of previous transactions (for example, ten times higher)?; did the user previously carry out transactions in favor of the counterparty of the current transaction (the receiver of the funds as a result of the transaction), or is this the first transaction being performed in favor of this counterparty? In this example, if the sum in the transaction is not typical or if the counterparty is a new one, the transaction may be declined by the bank or the user will have to additionally confirm the transaction (by two-factor authentication or telephone confirmation to a bank employee).

The transactions database 104 contains the parameters of the transactions of the set of users, as well as the attributes of these users. In an exemplary aspect the users can be divided up by the verification tool 106 into a certain number of classes. In one aspect, the dividing of the users into classes can be done either by the system administrator or by the verification tool 106, making use of classification algorithms or clustering algorithms.

When using a classification, the administrator assigns the number of classes and a training set—users for whom it is known in advance which class they belong to. Next, by using classification algorithms (for example, using the Bayes classifier, neural nets, linear dividers, decision trees, and so on), values are calculated for the attributes of the user and the parameters of the transaction, wherein the users from the training set will end up in the classes assigned by the administrator. Thus, new users who are absent from the training set will be classified with the use of the calculated values. The classification can be done using all or some of the transaction parameters or user attributes.

For example, users can be classified just by the user attribute “total funds in the bank account of the user”. In this example, the administrator assigns a number of classes (such as three) and a training set of users. After applying the classification algorithms, the values are determined for the total funds which can be used to classify new users. For example, to the first class will be assigned users whose total funds are less than $1000, to the second class users with total funds from $1000 to $10 000, and to the third class users with total funds over $10 000.

When using a clustering, the dividing of the users from the training set into classes is not specified, and therefore it is necessary to classify the users simply on the basis of their similarity to each other by attributes and parameters of transactions, making use of known clustering algorithms (such as the k-means method, the EM algorithm).

After obtaining the results from the use of the classification or clustering algorithms, there is determined for each class obtained a list of locations where the users of this class perform the largest number of transactions. The trust condition in this example will be the following condition: the location for initiation of the user's transactions coincides with a given accuracy with one from the list of locations where the largest number of transactions of other users of the class was initiated.

In yet another exemplary aspect, the verification tool 106 is additionally configured to determine a class of users with the use of the transactions database 104. In this example, the user in question may be assigned by the verification tool 106 to an exemplary class of users if two or more of the following listed conditions imposed on the parameters and attributes are fulfilled:
the total funds in the bank account of the user are above the total funds specified by the verification tool 106;
the location for initiation of the user's transactions coincides with a given accuracy with a location for initiation of transactions of other users of the class (for example, with an accuracy of 100 meters);
the location of the issuer bank of the user's bank account coincides with a given accuracy with the location of the issuer bank of other users of the class (for example, different branches of the bank in the same city);
the total funds in the bank account of the user coincide with such a total of other users of the class with an accuracy specified by the verification tool 106 (for example, with an accuracy of 20%); and/or
the type of bank card of the user corresponding to at least one aforementioned bank account of the user coincides with the type of bank cards of other users of the class.

In this exemplary aspect, an additional trust condition is as follows: the location for initiation of the user's transaction coincides with a given accuracy (for example, with an accuracy of 100 meters) with one of a specified number of locations (such as the 5 most common places) in which the largest number of transactions of other users of the class was initiated. For example, the users of a given class in 90% of the cases perform transactions in one of five cities of European countries. Then the trust condition is that the user transaction being verified was also initiated in one of these five cities. In an exemplary aspect, the user's attributes further contain the location of the issuer bank of the user's bank account. In another exemplary aspect, a further trust condition is when the location for initiation of the user's transaction is contained in a list of allowable locations as specified by the administrator.

In an exemplary aspect, the location of the transaction can be determined with the use of the following additional parameters of the transaction, for example:
a) the IP address of the user's device from which the transaction was initiated;
b) information about given Wi-Fi access point, if the transaction was initiated by this access point;
c) geographical coordinates of the user's device;
d) base stations in the reception zone of the user's device;
e) data of sensors of the user's device: altimeter, accelerometer, gyroscope, compass;
f) location of the ATM, if the transaction was initiated from there; and/or
g) location of the merchant, if the transaction was performed from a POS terminal of that merchant.

In one exemplary aspect, the IP address of the user's device can be determined when the transaction is, for example, an authorization in an Internet banking system. Parameters b) to e) can be determined, for example, when the user performs transactions from a mobile device and has additionally authorized the gathering and transmittal of the mentioned parameters to the issuer bank 101.

In an exemplary aspect, an additional trust condition is the presence of transactions meeting the following conditions:
the first transaction satisfies one or more trust conditions (which have been previously determined);
the distance from the location of the second transaction to the nearest airport or train station is less than a distance specified by the verification tool 106 (such as 100 meters).

This example describes the situation when the user has carried out two transactions in the course of a short interval of time. Here, the first transaction satisfies the main trust conditions, while the second transaction was initiated at an airport or train station, or sufficiently close to these structures. Thus, the system recognizes that it is highly likely that the user has gone to a different city by airplane or train, and the subsequent user transactions will be initiated already in another city or country. These transactions should not be declined, since the user's behavior is not fraudulent.

In another exemplary aspect, if the analysis tool 103 has received information on the initiation or execution of three or more transactions in a given interval of time (such as a day), an additional trust condition is the following initiation sequence of these transactions:
a) the distance between the location of initiation of the first and second transactions is less than a distance (for example, the distance between them is less than 10 kilometers, or they were initiated within the same city);
b) the difference in time between the first and second transactions is less than an interval of time A specified by the analysis tool 103 (such as 2 hours);
c) the second transaction was initiated near an airport A (first geographical location);
d) the third transaction was initiated near an airport B (or second geographical location);
e) the difference in time between the second and third transactions is greater than an interval of time B specified by the analysis tool 103 (for example, the time is commensurate to the time needed to fly between airports A and B (between two geographical locations)).

This example describes a situation when the user has moved between two cities or countries by transportation (train, airplane, ferry, etc.). Thus, if he has performed transactions during this time, they should be consistent with his itinerary. A situation where two transactions have been initiated by the same user with a slight time difference (such as 5 minutes) in different cities or even countries may testify to a fraudulent event and the transactions should be blocked. At the same time, if the time difference is comparable to the time of flight between these cities and, furthermore, the user has performed transactions at both airports of these cities, such transactions are most likely not fraudulent and will be approved.

In the given example, the first transaction was initiated by the user in a city, the second at an airport of this city (or at another transportation hub), and the third at an airport of a second city. It should be noted that there can also be other intermediate transactions between these transactions.

In an exemplary aspect, the specified first and second distances mentioned in the examples and the specified first and second intervals of time can be saved in the database of trust conditions 105. In yet another exemplary aspect, these variables can depend on the location and other parameters. For example, if there are no direct flights between two particular airports, then the travel time between them will be increased in accordance with the existing flights with transfers.

Advantageously, the described system is configured to detect a larger number of legitimate user transactions than the systems described in the prior art, thereby reducing the probability of making mistakes of the first kind when checking transactions for being trusted (i.e., not recognizing a transaction as trusted when it really is).

Furthermore, the described system is able to eliminate the need for banks having to ask the user for confirmation of transactions initiated in other cities or countries and, consequently, the system simplifies the procedure for verifying the security of transactions.

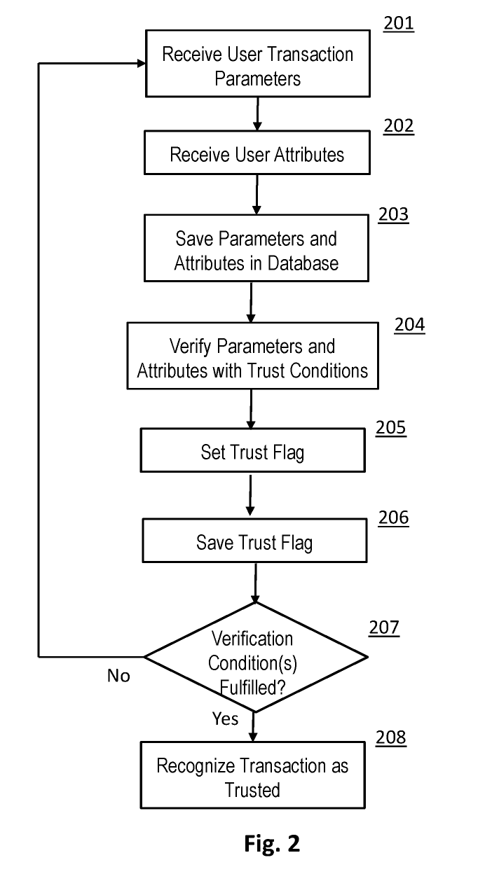

FIG. 2 illustrates a flowchart for a method for recognizing transactions as trusted according to an exemplary aspect. As shown, in step 201 the parameters of a user transaction are received using the analysis tool 103 via the network 102 from the issuer bank 101. In step 202 the analysis tool 103 also receives the user's attributes from the issuer bank 101 and, in step 203, the analysis tool 103 saves the received parameters of the user's transaction and the user's attributes in the transactions database 104. The description of the transaction parameters and user's attributes has been given above in the description for FIG. 1. Next, in step 204, the fulfillment of the trust conditions from the database of trust conditions 105 is verified with the aid of the verification tool 106. If the specified number of trust conditions is not fulfilled, the transaction is not recognized as trusted. The trust condition determines that the parameters of the user's transactions and the user's attributes are in a range of values specified by the verification tool 106. A trust condition can be imposed on an exemplary sequence of user transactions. Specific examples of trust conditions have been given above in Table 1. Trust conditions can be evaluated sequentially according to one exemplary aspect.

In the alternative, if the specified number of trust conditions is fulfilled, the verification tool 106 defines the particular transaction as trusted and sets a trust flag in step 205, and in step 206 the verification tool 106 saves the trust flag for the particular transaction in the transactions database 104. The trust flag is an indicator determining that the transaction is trusted. Steps 201-206 are repeated until, in step 207, the verification condition occurs: a specified number of trusted transactions of the user have been saved in a row in the transactions database 104 for which the trust flag has been determined in the transactions database 104. As a result, in step 207, the subsequent user transaction will be recognized as trusted. This information is dispatched by the verification tool 106 to the issuer bank 101. As a result, the issuer bank 101 allows the subsequent transactions of the user. In an exemplary aspect, the issuer bank 101 may use a supplemental analysis to determine whether a transaction is trusted. An example of such a supplemental analysis was given above in the description for FIG. 1.

The transactions database 104 contains the parameters of the transactions of a set of users, as well as the attributes of these users. In an exemplary aspect, the users can be divided up by the verification tool 106 into a certain number of classes. A more detailed description of aspects of the methods of dividing up the users into classes has been given above, in the description of FIG. 1. In an exemplary aspect the verification tool 106 additionally determines with the use of the transactions database 104 the class of users to which the user belongs upon fulfillment of two or more of the following listed conditions imposed on the parameters and attributes:
the total funds in the bank account of the user are above the total funds specified by the verification tool;
the location for initiation of the user's transactions coincides with a given accuracy with a location for initiation of transactions of other users of the class (for example, with an accuracy of 100 meters);
the location of the issuer bank of the user's bank account coincides with an accuracy specified by the verification tool with the location of the issuer bank of other users of the class (for example, different branches of the bank in the same city);
the total funds in the bank account of the user coincide with such a total of other users of the class with a given accuracy (for example, with an accuracy of 20%);
the type of bank card of the user corresponding to at least one aforementioned bank account of the user coincides with the type of bank cards of other users of the class.

In this exemplary aspect, one of the trust conditions is: the location for initiation of the user's transaction coincides with a given accuracy (for example, with an accuracy of 100 meters) with one of a specified number of locations (such as the 5 most common places) in which the largest number of transactions of other users of the class was initiated. In another exemplary aspect, the user's attributes further contain the location of one or more bank accounts of the user. In yet another exemplary aspect, a further trust condition is when the location for initiation of the user's transaction is contained in a list of allowable locations as specified by the administrator.

In an exemplary aspect, the location of the transaction may be determined with the use of the following additional parameters of the transaction:
a) the IP address of the user's device from which the transaction was initiated;
b) information about given Wi-Fi access points, if the transaction was initiated by this access point;
c) geographical coordinates of the user's device;
d) base stations in the reception zone of the user's device;
e) data of sensors of the user's device: altimeter, accelerometer, gyroscope, or compass;
f) location of the ATM, if the transaction was initiated from there;
g) location of the merchant, if the transaction was performed from a POS terminal of that merchant.

The IP address of the user's device can be determined when the transaction is, for example, an authorization in an Internet banking system. Parameters b) to e) can be determined, for example, when the user performs transactions from a mobile device and has additionally authorized the gathering and transmittal of the mentioned parameters to the issuer bank 101.

In an exemplary aspect, an additional trust condition is the presence of transactions meeting the following conditions:
the first transaction satisfies one or more trust conditions (which have been previously determined);
the distance from the location of the second transaction to the nearest airport or train station is less than a specified distance (such as 100 meters).

This example describes the situation when the user has carried out two transactions in the course of a short interval of time. Here, the first transaction satisfies the main trust conditions, while the second transaction was initiated at an airport or train station, or sufficiently close to these structures. Thus, it is highly likely that the user has gone to a different city by airplane or train, and the subsequent user transactions will be initiated already in another city or country. According to the exemplary aspect, these transactions should not be declined, since the user's behavior is not fraudulent.

In another exemplary aspect, if three or more transactions were initiated or executed in a given interval of time (such as a day), an additional trust condition is the following initiation sequence of these transactions:
a) the distance between the location of initiation of the first and second transactions is less than a distance (for example, the distance between them is less than 10 kilometers, or they were initiated within the same city);
b) the difference in time between the first and second transactions is less than an interval of time A specified by the analysis tool 103 (such as 2 hours);
c) the second transaction was initiated near an airport A (first geographical location);
d) the third transaction was initiated near an airport B (second geographical location);
e) the difference in time between the second and third transactions is greater than an interval of time B specified by the analysis tool 103 (for example, the time is commensurate to the time needed to fly between airports A and B (first and second geographical locations)).

This example describes a situation when the user has moved between two cities or countries by transportation (train, airplane, ferry, etc.). Thus, if he has performed transactions during this time, they should be consistent with his itinerary. A situation where two transactions have been initiated by the same user with a slight time difference (such as 5 minutes) in different cities or even countries may testify to a fraudulent event and the transactions should be blocked. At the same time, if the time difference is comparable to the time of flight between these cities and, furthermore, the user has performed transactions at both airports of these cities, such transactions are most likely not fraudulent and will be approved.

In the given example, the first transaction was initiated by the user in a city, the second at an airport of this city (or at another transportation hub), and the third at an airport of a second city. It should be noted that there can also be other intermediate transactions between these transactions.

In an exemplary aspect, the specified first and second distances mentioned in the examples and the specified first and second intervals of time can be saved in the database of trust conditions 105. In yet another particular aspect, these variables can depend on the location and other parameters. For example, if there are no direct flights between two particular airports, then the travel time between them will be increased in accordance with the existing flights with transfers.

FIG. 3 illustrates an example of a general-purpose computer system (which may be a personal computer or a server) on which the disclosed systems and method can be implemented according to an example aspect. For example, the computer system illustrated in FIG. 3 can be provided to implemented one or more of the analysis tool 103, the verification tool 106, the transaction database 104 and the database of trust levels 105. As shown, the computer system 20 includes a central processing unit 21, a system memory 22 and a system bus 23 connecting the various system components, including the memory associated with the central processing unit 21. The system bus 23 is realized like any bus structure known from the prior art, including in turn a bus memory or bus memory controller, a peripheral bus and a local bus, which is able to interact with any other bus architecture. The system memory includes read only memory (ROM) 24 and random-access memory (RAM) 25. The basic input/output system (BIOS) 26 includes the basic procedures ensuring the transfer of information between elements of the personal computer 20, such as those at the time of loading the operating system with the use of the ROM 24.

The personal computer 20, in turn, includes a hard disk 27 for reading and writing of data, a magnetic disk drive 28 for reading and writing on removable magnetic disks 29 and an optical drive 30 for reading and writing on removable optical disks 31, such as CD-ROM, DVD-ROM and other optical information media. The hard disk 27, the magnetic disk drive 28, and the optical drive 30 are connected to the system bus 23 across the hard disk interface 32, the magnetic disk interface 33 and the optical drive interface 34, respectively. The drives and the corresponding computer information media are power-independent modules for storage of computer instructions, data structures, program modules and other data of the personal computer 20.

The present disclosure provides the implementation of a system that uses a hard disk 27, a removable magnetic disk 29 and a removable optical disk 31, but it should be understood that it is possible to employ other types of computer information media 56 which are able to store data in a form readable by a computer (solid state drives, flash memory cards, digital disks, random-access memory (RAM) and so on), which are connected to the system bus 23 via the controller 55.

The computer 20 has a file system 36, where the recorded operating system 35 is kept, and also additional program applications 37, other program modules 38 and program data 39. The user is able to enter commands and information into the personal computer 20 by using input devices (keyboard 40, mouse 42). Other input devices (not shown) can be used: microphone, joystick, game controller, scanner, and so on. Such input devices usually plug into the computer system 20 through a serial port 46, which in turn is connected to the system bus, but they can be connected in other ways, for example, with the aid of a parallel port, a game port or a universal serial bus (USB). A monitor 47 or other type of display device is also connected to the system bus 23 across an interface, such as a video adapter 48. In addition to the monitor 47, the personal computer can be equipped with other peripheral output devices (not shown), such as loudspeakers, a printer, and so on.

The personal computer 20 is able to work in a network environment, using a network connection to one or more remote computers 49. The remote computer (or computers) 49 are also personal computers or servers having the majority or all of the aforementioned elements in describing the nature of a personal computer 20, as shown in FIG. 3. Other devices can also be present in the computer network, such as routers, network stations, peer devices or other network nodes.

Network connections can form a local-area computer network (LAN) 50, such as a wired and/or wireless network, and a wide-area computer network (WAN). Such networks are used in corporate computer networks and internal company networks, and they generally have access to the Internet. In LAN or WAN networks, the personal computer 20 is connected to the local-area network 50 across a network adapter or network interface 51. When networks are used, the personal computer 20 can employ a modem 54 or other modules for providing communications with a wide-area computer network such as the Internet. The modem 54, which is an internal or external device, is connected to the system bus 23 by a serial port 46. It should be noted that the network connections are only examples and need not depict the exact configuration of the network, i.e., in reality there are other ways of establishing a connection of one computer to another by technical communication modules, such as Bluetooth.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In various aspects, the systems and methods described in the present disclosure in terms of modules or tools. These terms as used herein refers to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A tool or module can also be implemented as a combination of the two, with certain functions facilitated by hardware alone, and other functions facilitated by a combination of hardware and software. In certain implementations, at least a portion, and in some cases, all, of a tool or module can be executed on the processor of a general purpose computer (such as the one described in greater detail in FIG. 3 above). Accordingly, each toot or module can be realized in a variety of suitable configurations, and should not be limited to any example implementation exemplified herein.

In the interest of clarity, not all of the routine features of the aspects are disclosed herein. It will be appreciated that in the development of any actual implementation of the present disclosure, numerous implementation-specific decisions must be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for verifying electronic transactions as trusted, the method comprising:
receiving, by a processor, at least one parameter for each of a plurality of transactions executed by a user;
obtaining, by the processor, at least one attribute of the user from a bank associated with the user;
storing, in a database, the parameters of the plurality of transactions and the at least one attribute of the user;
for each of the plurality of transactions, determining, by the processor, whether a predetermined number of trust conditions are met by the at least one parameter of the transaction and the at least one attribute of the user;
for each of the plurality of transactions, determining, by the processor, that the transaction is trusted if the predetermined number of the trust conditions are met;
determining that a verification condition is met if the processor determines that a specified number of the plurality of transactions is determined to be trusted; and
recognizing a subsequent transaction executed by the user is trusted if the verification condition is met.

2. The method of claim 1, wherein the at least one parameter for each of at least a pair of the plurality of transactions executed by the user is a geographical location of a user device that executed each transaction.

3. The method of claim 2, wherein the trust conditions of one of the pair of transactions is that the one transaction was executed at a first geographical location within a predetermined distance of a second geographical location of the user device when the other of the pair of transactions was executed.

4. The method of claim 2, wherein the trust conditions of the pair of transactions is that one of the pair of transactions was executed after a time interval from when the other of the pair of transactions was executed, and the time interval is greater than an expected travel time of the user between two geographical locations.

5. The method of claim 2, wherein the trust conditions include that the geographical location of the user device that executed each transaction coincides within a given accuracy with one of a plurality of a predetermined geographical locations.

6. The method of claim 1, wherein the at least one parameter for each of the plurality of transactions executed by the user comprises at least one of an identifier of the user, an identifier of the transaction, an identifier of a user device that executed the transaction, a time of initiation of the transaction, and a geographical location of the initiation of the transaction.

7. The method of claim 1, wherein the at least one attribute of the user comprises at least one of total funds in a bank account of the user and a type of bank card of the user that corresponds to a bank account of the user.

8. The method of claim 1, further comprising:
assigning the user to one of a plurality of user classifications based on the at least one parameter for each of the plurality of transactions executed by the user and the at least one attribute of the user; and
determining that the verification condition is met based at least partially on the assigned user classification of the user.

9. The method of claim 8, further comprising assigning the user to one of the plurality of user classifications if at least two of the following conditions for the parameters and attributes are satisfied:
total funds in a bank account of the user exceed a predetermined threshold;
a geographical location for initiation of the transactions coincides with a given accuracy with a geographical location for initiation of transactions of other users of the user classification;
a geographical location of the bank of a bank account of the user coincides with a given accuracy with the geographical location of a bank of other users of the user classification class;
the total funds in the bank account of the user coincide with totals of the other users of the user classification class within a specified accuracy; and
a type of bank card of the user corresponds to a type of bank cards of the other users of the user classification.

10. The method of claim 1, wherein the determining that the predetermined number of trust conditions are met is performed sequentially until the predetermined number is reached.

11. A system for verifying electronic transactions as trusted, the system comprising:
a database; and
a processor configured to:
obtain at least one parameter for each of a plurality of transactions executed by a user,
obtain at least one attribute of the user from a bank associated with the user;
store the at least one parameter for each of the plurality of transactions and the at least one attribute of the user in the database,
for each of the plurality of transactions, determine whether a predetermined number of trust conditions are met by the at least one parameter of the transaction and the at least one attribute of the user,
for each of the plurality of transactions, determine that the transaction is trusted if the predetermined number of trust conditions are met,
determine that a verification condition is met if the processor determines that a specified number of the plurality of transactions is determined to be trusted, and
recognize a subsequent transaction executed by the user is trusted if the verification condition is met.

12. The system of claim 11, wherein the at least one parameter for each of at least a pair of the plurality of transactions executed by the user comprises a geographical location of a user device that executed each transaction.

13. The system of claim 12, wherein the trust conditions of one of the pair of transactions is that the one transaction was executed at a first geographical location within a predetermined distance of a second geographical location of the user device when the other of the pair of transactions was executed.

14. The system of claim 12, wherein the trust conditions of the pair of transactions is that one of the pair of transactions was executed after a time interval from when the other of the pair of transactions was executed, and the time interval is greater than an expected travel time of the user between two geographical locations.

15. The system of claim 12, wherein the trust conditions include that the geographical location of the user device that executed each transaction coincides within a given accuracy with one of a plurality of a predetermined geographical locations.

16. The system of claim 11, wherein the at least one parameter for each of the plurality of transactions executed by the user comprises at least one of an identifier of the user, an identifier of the transaction, an identifier of a user device that executed the transaction, a time of initiation of the transaction, and a geographical location of the initiation of the transaction.

17. The system of claim 11, wherein the at least one attribute of the user comprises at least one of total funds in a bank account of the user and a type of bank card of the user that corresponds to a bank account of the user.

18. The system of claim 11, wherein the processor is further configured to:
assign the user to one of a plurality of user classifications based on the at least one parameter for each of the plurality of transactions executed by the user and the at least one attribute of the user; and
determine that the verification condition is met based at least partially on the assigned user classification of the user.

19. The system of claim 18, wherein the processor is further configured to assign the user to one of the plurality of user classifications if at least two of the following conditions for the parameters and attributes are satisfied:
total funds in a bank account of the user exceed a predetermined threshold;
a geographical location for initiation of the transactions coincides with a given accuracy with a geographical location for initiation of transactions of other users of the user classification;
a geographical location of the bank of a bank account of the user coincides with a given accuracy with the geographical location of a bank of other users of the user classification class;
the total funds in the bank account of the user coincide with totals of the other users of the user classification class within a specified accuracy; and
a type of bank card of the user corresponds to a type of bank cards of the other users of the user classification.

20. A non-transitory computer readable medium storing computer executable instructions for verifying electronic transactions as trusted, including instructions for:
receiving at least one parameter for each of a plurality of transactions executed by a user;
obtaining at least one attribute of the user from a bank associated with the user;
storing, in a database, the parameters of the plurality of transactions and the at least on attribute of the user;
for each of the plurality of transactions, determining whether a predetermined number of trust conditions are met by the at least one parameter of the transaction and the at least one attribute of the user;
for each of the plurality of transactions, determining that the transaction is trusted if the predetermined number of trust conditions are met;
determining that a verification condition is met if a specified number of the plurality of transactions is determined to be trusted; and
recognizing a subsequent transaction executed by the user is trusted if the verification condition is met.
